(19) United States
(12) Patent Application Publication
(10) Pub. No.: US 2012/0249764 A1
(43) Pub. Date: Oct. 4, 2012

(54) CERVICAL, FETAL-MEMBRANE, AND AMNIOTIC EXAMINATION AND ASSESSMENT DEVICE AND METHOD

(76) Inventors: Ruben Kuon, Heidelberg (DE); William L. Maner, Phoenix, AZ (US); Robert E. Garfield, Goodyear, AZ (US); Richard Blumrick, Gilbert, AZ (US)

(21) Appl. No.: 13/389,175

(22) PCT Filed: Aug. 9, 2010
(86) PCT No.: PCT/US2010/044907

§ 371 Date: Jun. 18, 2012

Related U.S. Application Data
(60) Provisional application No. 61/232,322, filed on Aug. 7, 2009.
(60) Provisional application No. 61/300,304, filed on Feb. 1, 2010.

(51) Int. Cl. H04N 7/18

(52) U.S. Cl. 348/67; 348/E07.085

(57) ABSTRACT

Some embodiments of the invention provide a cervical, fetal-membrane, and amniotic examination and assessment device for use with a computer and a method for examining a cervix with the device. The device can include a probe with a camera and a reference laser system, a cable coupling the probe to the computer, and a device program executable by the computer. One method includes positioning a laser to illuminate a reference dot on a target area of the cervix, calculating a distance between the probe and the cervix using the reference laser system, capturing images of the target area at a desired distance using the camera, identifying features of the cervix, and measuring and quantifying boundaries of the features using the desired distance and an area of the reference dot in the images.

### RELATED APPLICATIONS

This application claims priority under 35 U.S.C. §119 to U.S. Provisional Patent Application Nos. 61/232,322 filed on Aug. 7, 2009, and 61/300,304 filed on Feb. 1, 2010, the entire contents of which are incorporated herein by reference.

### BACKGROUND

There are limited devices currently available to accurately assess a state of pregnancy of a patient or whether labor or delivery is imminent. Cervical assessment for predicting labor is performed primarily by crude digital exams, or by ultrasound exam, with limited results. Also, there are no visual instruments available to accurately assess amniotic infection or other abnormalities in non-pregnant and/or pregnant patients (e.g., distocia, displasia, incompetences, inflammation, cervicitis, etc.). Infections are currently assessed with blood tests (e.g., checking leukocytes or glucose), with limited results, and cultures, which can take a substantial amount of time to evaluate.

### SUMMARY

Some embodiments of the invention provide a cervical, fetal-membrane, and amniotic examination and assessment device for use with a computer. The device may include a probe including a camera and a reference laser system including a laser. The laser can be located on the probe relative to the camera to illuminate a reference dot on a target area to be photographed by the camera. The reference laser system can determine a distance between the probe and a target structure within the target area. The device can also include a cable coupling the probe to the computer and configured to transmit images of the target area photographed by the camera and the distance determined by the reference laser system to the computer. The device can further include a device program executable by the computer which analyzes the images to measure and quantify boundaries of features within the target area using the reference dot in the images and the determined distance from the reference laser system.

Some embodiments of the invention provide a method for examining a cervix with an examination and assessment device. One method may include providing the examination and assessment device with a probe including a camera and a reference laser system and coupled to a computer, positioning a laser to illuminate a reference dot on a target area of the cervix, calculating a first distance between the probe and the cervix using the reference laser system, and triggering an indicator light when the first distance equals a desired distance. The method can also include capturing images of the target area at the desired distance using the camera, identifying features of the cervix by analyzing visual variations within the images, and measuring and quantifying boundaries of the features using the desired distance and an area of the reference dot in the images.

### DESCRIPTION OF THE DRAWINGS

FIG. 1 is a perspective view of a cervical, fetal-membrane, and amniotic examination and assessment device according to one embodiment of the invention.

FIG. 2 is front view of a probe of the device of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

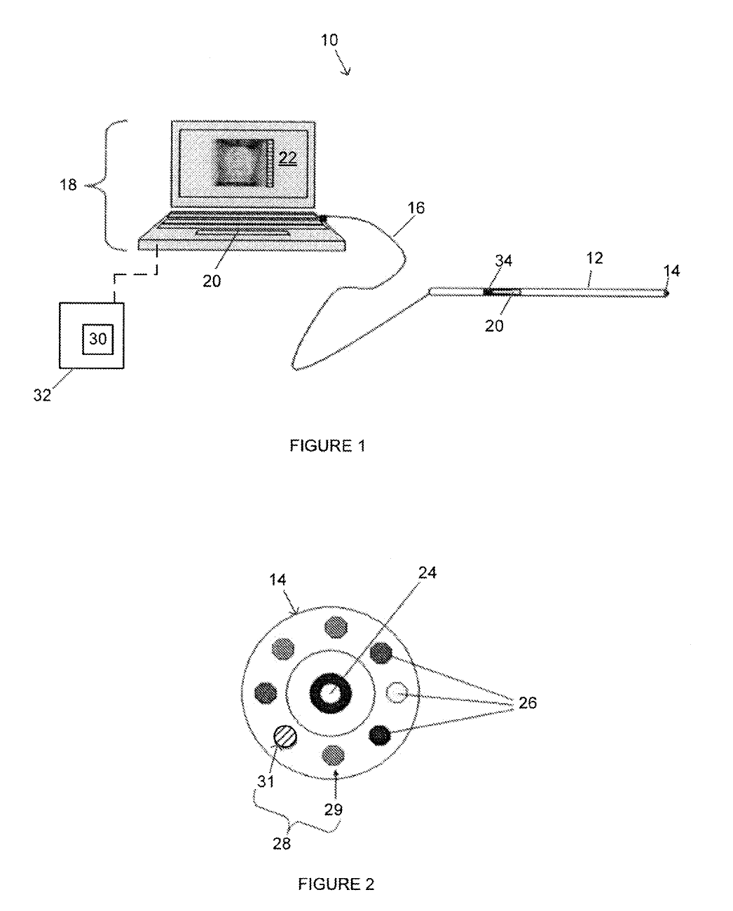

FIG. 1 illustrates a cervical, fetal-membrane, and amniotic examination and assessment device 10 according to one embodiment of the invention. The device 10 can include a probe 12, a camera lens housing 14, a connector cable 16, a computer 18, a control panel 20, and a display screen 22. The device 10 can be used by an examiner (i.e., a first user) on a patient (i.e., a second user). More specifically, the examiner can use the device 10 to examine and assess the patient's cervix, fetal-membrane, or amniotic fluid.

In some embodiments, the probe 12 (e.g., a fiber-optic probe) can be positioned by the examiner to capture images of the patient's cervix, or another target area of the patient (e.g., amniotic fluid or fetal-membrane). In some embodiments, the probe 12 can be similar to a conventional colposcope (i.e., a device used to subjectively assess cancer in a cervix). As shown in FIG. 2, the probe 12 can include a camera 24 (e.g., a high-resolution camera), with magnifying capabilities, for capturing cervical images of the patient. The probe 12 can also include one or more light sources 26, such as light-emitting diodes (LEDs). The light sources 26 can include visible light, infrared light, black light (i.e., ultraviolet light), or light of other frequencies. Also, the light sources 26 can be positioned relative to the camera 24 to illuminate a target area (i.e., of the cervix or other target structure) to be photographed by the camera 24. As a result, the camera 24 can capture images of the target area in different light spectrums. Some of the light sources 26 can produce light at different intensities and/or all of the light sources 26 can have adjustable intensities for different lighting and imaging of the cervix or target structure.

The probe 12 can also include a reference laser system 28. In some embodiments, the reference laser system 28 can comprise a laser range-finder and can be used to determine and standardize a distance between the camera 24 or an end of the probe 12 and the cervix or other target structure. For example, the reference laser system 28 can include a laser 29 and a detector 31, as shown in FIG. 2, and a distance-measuring subsystem (not shown). In some embodiments, the distance-measuring subsystem can be located inside the probe 12 and can be in communication with both the laser 29 and the detector 31.

The distance-measuring subsystem can use the laser 29 and the detector 31 to determine a distance between the probe 12 and the target structure using a distance-measuring technique or algorithm, such as a “time of flight” technique or a multiple frequency phase-shift technique. Using the time of flight technique, the distance-measuring subsystem can measure a travel time for a light pulse from the laser 29 to travel to the target structure and back to the detector 31. The distance can then be calculated using the travel time and the speed of light. In one embodiment, multiple pulses can be fired sequentially and an average travel time can be used. Using the multiple frequency phase-shift technique, the distance-measuring subsystem can measure a phase shift of multiple frequencies of laser light reflection detected by the detector 31, then solve simultaneous equations determine the distance. The distance-measuring subsystem can also use interferometry for measuring the distance between the probe 12 and the target structure. Other distance-measuring techniques and devices, as well as additional lasers 29 and detectors 31, can also be used with the device 10.

In some embodiments, the laser 29 can be located on the probe 12 relative to the camera 24 so that it can illuminate a continuous visual reference “dot” of known area on the cervix or target structure (i.e., within the target area) in the images photographed by the camera 24. Also, in some embodiments, the detector 31 can be located on the probe 12 relative to the laser 29 in order to detect properties of reflections of the laser 29 from the target structure. For example, the detector 31 can be located on a front portion (i.e., camera-end) of the probe 12, either on the camera lens housing 14, as shown in FIG. 2, or enclosed by the camera lens housing 14.

In one embodiment, the camera 24, the light sources 26, and the reference laser system 28 can be enclosed by the camera lens housing 14. In another embodiment, the light sources 26 can be positioned on the camera lens housing 14, and the camera 24 and the reference laser system 28 can be enclosed by the camera lens housing 14. In yet another embodiment, the light sources 26, the laser 29, and the detector 31 can be positioned on the camera lens housing 14 (as described above), and the camera 24 and the distance-measuring subsystem can be enclosed by the camera lens housing 14. Also, in one embodiment, an additional laser (i.e., other than the laser 29 used with the reference laser system 28) can take the place of one of the light sources 26 enclosed by the camera lens housing 14 or positioned on the camera lens housing 14 and can be used to illuminate the reference dot on the target structure.

In addition, the probe 12 and the camera lens housing 14 can each be sealed so that they are waterproof. In some embodiments, the device 10 can include mounts (not shown) coupled to the probe 12 and/or the camera lens housing 14 for affixing biopsy tools, syringes, scalpels, and/or other diagnostic or surgical tools which can be used in conjunction with the camera 24. In one embodiment, the probe 12 can include a hinge (not shown), allowing the examiner to adjust the camera angle for capturing an image.

The connector cable 16 (e.g., a fiber-optic cable) can connect the probe 12 to the computer 18. The cable 16 can transmit information such as camera settings from the computer 18 to the camera 24. The cable 16 can also transmit information such images captured and/or other data acquired from the probe 12 and/or the camera 24 to the computer 18. One example of other data acquired can include a distance between the probe 18 and the target structure, as determined by the reference laser system 28 (i.e., as determined by the distance-measuring subsystem). In one embodiment, the connector cable 16 can transmit illuminating light (i.e., of the light sources 26) from an external source to the probe 12.

In some embodiments, the computer 18 can include image processing software and a neural networks classifier for controlling the camera 24 (e.g., adjusting settings, capturing images, etc.), for monitoring and analyzing images captured, and for data acquisition. The image processing software can control the computer 18 to automatically and objectively determine boundaries of the patient's cervix (or another target structure) using the images captured and/or other acquired data. The computer 18 can also automatically mark such boundaries on the captured image and/or calculate equations or (x, y) point plots for the boundaries.

More specifically, in some embodiments, the image processing software can control the computer 18 to retrieve the probe's distance from the visual target structure (i.e., by retrieving data from the distance-measuring subsystem of the reference laser system 28) and calculate an area of the reference dot in the captured images in order to determine area calculations of the target structure and features within the target area. More specifically, the calculated area of the reference dot can be used to scale the captured images so that areas of the features (i.e., areas within the features' boundaries) can be quantified. In some embodiments, the area calculations can be used as cervical or amniotic membrane assessment parameters. In addition, the image processing software can control the computer 18 to digitize the images, and enhance and quantify the digitized images using measured characteristics such as color, shape, size, texture, etc. for automatic processing of certain features within the target area. For example, in some embodiments, the computer 18 can compare digital pixels of the image to determine the features and boundaries of the features.

The cervix can go through many morphological, textural, and color changes, which reflect the underlying structure, composition, ripening state or infection state. As a result, the assessments determined by the computer 18 can be used to automatically and objectively categorize a cervical or amniotic membrane condition or state and any anomalies or infection thereof, therefore more accurately determining the pregnancy state of the patient, more accurately predicting imminent labor and delivery, and/or more accurately assessing anomalies or infection.

The computer 18 can include the display screen 22 to display the images captured for the examiner and the patient. Also, the data received by the computer 18 can be processed and personalized or modified directly on the computer 18 by the examiner. For example, boundaries can be determined for certain features of the target area and visual boundary marks can be displayed to the examiner and the patient through the display screen 22. The examiner can manually re-determine boundaries of any features in the displayed, or “on-screen”, image. In one embodiment, the display screen 22 can include touch-pad capabilities and the examiner can modify boundaries using a touch-pen to draw in new boundaries directly on the display screen 22. in addition, the patient's medical data can be entered into the computer 18, and the acquired data (i.e., images and assessments) can be added to the patient's medical data through additional algorithms or software carried out by the computer 18. All data can be saved on storage media of the computer 18 or an external database and, in some embodiments, printed out using a printer.

Controls for the camera 24, the light sources 26, and/or the reference laser system 28 can be adjusted by the examiner using the control panel 20. in one embodiment, the control panel 20 can be positioned on the probe 12. In another embodiment, the control panel 20 can be integrated with the computer 18, as shown in FIG. 1, or on a different device, such as a pedal. The control panel 20 can receive input from the examiner to control focusing, magnification, mode, picture capture, etc. of the camera 24, on/off, intensity adjusting, selection of frequencies (e.g., only visible light or only infrared light), etc. of the light sources 26, and/or desired distance input, on/off, etc. of the reference laser system 28.

The following paragraphs describe an example procedure for using the device 10 according to one embodiment of the invention.

First, the examiner can access the vaginal canal of the patient by opening it sufficiently using a speculum. Because of the variation in vaginal characteristics, the device 10 can be used in conjunction with any size speculum. Next, the probe 12 can be placed trans-vaginally (i.e., camera-end first) and pressed or pushed in toward the cervix or other target structure of the patient.

The reference laser system 28 can be used to standardize a distance of the camera 24 from the cervix or other target structure. A distance-measuring technique carried out by the reference laser system 28 can cause an indicator light 34 on the computer 18 or on the probe 12 (e.g., as shown in FIG. 1 on the control panel 20) to turn on when the camera 24 has been positioned at the predetermined or desired distance from the cervix or other target structure. Once at the desired distance, the image processing software can control the computer 18 to calculate the area of the laser's projected reference dot on captured images from the camera 24. As a result, the laser 29 can be used to project the continuous visual reference dot of known area on the cervix, which can be present during all subsequent capturing of images for scaling purposes and adjusted automatically in relation to the desired distance to the cervix or other target structure. In addition, in some embodiments, the reference laser system 28 can retrieve the desired distance from examiner input to the computer 18 or the control panel 20. In other embodiments, the reference laser system 28 can retrieve a standard distance saved in computer readable media of the computer 18, readable by the computer, or of a separate database or server.

The light sources 26 of visible, infrared, black light, and/or other frequencies can be controlled by the examiner to illuminate the cervix (or other target structure). In some embodiments, the cervix may or may not be already prepared with acid, iodine, or other washes, or with injections or washes of nano-particles or dyes which specifically bind to collagen, T-cells, antibodies, proteins, and/or other cervical components or infection entities. One or several of the light sources 26 can be used for subsequent different lighting and imaging of the cervix or target structure. The camera 24 can capture the cervical image in visible, infrared, and other frequencies from light reflected, fluoresced, phosphoresced, or otherwise emitted from the cervix, as controlled by the examiner through the control panel 20. The camera 24 can be adjustable for magnification from, for example, about 1× magnification to about 1000× magnification. The camera lens housing 14 and/or the probe 12 can also include mounts (not shown) for coupling biopsy tools, syringes, scalpels, and/or other diagnostic or surgical tools which can be used in conjunction with the camera 24.

The computer 18 can receive the images from the camera 24 (i.e., through the connector cable 16) and the image processing software can control the computer 18 to automatically determine boundaries of the cervix, as well as boundaries of any cervical anomalies (e.g., infection regions, displasia, neoplasia, etc.), by analyzing reflection, phosphorescence, luminescence, infrared light intensities, color, and/or other visual variations throughout the target area, as further described below. The computer 18 can also automatically mark such boundaries on the captured image and calculate equations or (x, y) point plots for the cervical and anomalous boundaries. The computer 18 can use the reference dot to calculate areas of the cervix and/or other features (such as anomalous regions) using the boundaries set in the image. The computer 18 can display the cervical image (captured and pixilated), along with visual boundary markings of the cervix and any other features on the display screen 22 (which can also serve as a touch-screen or touchpad) or on a hand-held or other external unit.

The examiner can manually re-determine the boundaries of any features in the on-screen image based on his or her own clinical assessment and experience and can draw in new boundaries of those features directly on the display screen 22 using a touch-pen (or computer mouse or other instrument). The computer 18 can then save the image and boundaries upon command from the examiner.

As described above, in some embodiments, the control panel 20 on the probe 12 (or on the computer 18, a pedal, or an equivalent instrument) can allow the examiner to operate the reference laser system 28 or the light sources 26 to illuminate the target area, to operate the camera 24 to capture images, to operate the computer 18 to save images, and, optionally, to change boundary areas on displayed images.

The computer 18 can execute a neural network program with inputs from the image processing software (such as analyses of light intensities, reflection, phosphorescence, and luminescence from the cervix and anomalous regions, areas of the cervix and anomalous regions, number of anomalous regions, shape of the cervix and anomalous regions, color distributions of the cervix and anomalous regions, and any other visual data or parameters calculable from the images), in order to classify the image according to labor vs. non-labor, infection vs. non-infection, displasia vs. non-displasia, etc. by comparing the image to other images captured and stored from other patients. The neural network program can retrieve the other images captured from other patients from computer readable media of the computer 18, separate computer readable media (e.g., DVD, CD-ROM, or similar media), or a database or server in communication with the computer 18 which includes the other images stored on computer readable media. The neural network program can also use other input parameters not taken directly by the camera 24, such as cervical texture and patient demographics or other patient clinical data.

In some embodiments, a single device program 30 can comprise the neural network program, the image processing software, and/or other software associated with the device 10 and can be stored on computer readable media executable by the computer 18. In some embodiments, the computer 18 can be a special-purpose computer dedicated to the device 10, in other embodiments, the device 10 can include the device program 30 on separate computer readable media 32 (e.g., DVD, CD-ROM, or similar media), as shown in FIG. 1, and the computer 18 can be a general-purpose computer capable of executing the device program and being coupled to the probe 12.

For the purposes of this disclosure a computer readable medium stores computer data, which data can include computer program code that is executable by a computer (i.e., the computer 18), in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some or all of the procedures described above can be performed using the device 10 on fetal membranes or amniotic fluid by placing the camera portion of the probe 12 within the cervical canal so as to capture images of the fetal membrane and amniotic fluid.

As described above, the device 10 can objectively and automatically assess a state of a cervix and amniotic membrane of a patient by acquiring visual images and quantifying visual characteristics and parameters (such as color, shape, size, texture, etc.) of features of the cervix and/or by comparing the features and calculated parameters to parameters of other stored images. More specifically, the device 10 can automatically and objectively categorize a pregnancy state (e.g., labor vs. non labor, term and preterm), cervical ripening, and/or infection state of the cervix, fetal membranes, and/or amniotic fluid (e.g., from enzymatic reactions due to collagen breakdown, or from local infection), as well as cervical shape (morphology), color, size or area, and cervical abnormalities (e.g., dysplasia, distocia, incompetence, inflammation, cervicitis, etc.). The device 10 can also determine boundaries of the cervix and any infected areas or other features by computing and analyzing visible and non-visible light intensity, infrared intensity, and visible color variations using the image processing software. Shape, color, area, visible and infrared light intensity (and other non-visible electromagnetic light frequencies such as ultraviolet light) can be used to observe cervical structure, collagen, T-cells, or microbes. Traditional washes, such as acetic acid and iodine, or special dyes or nano-particles (locally applied or injected) specifically designed bind to T-cell, collagen, proteins, and/or antibodies in the cervix can be used in conjunction with the device 10 for improving image capture and assessment.

In some embodiments, the device 10 can be used as a minimally-invasive, objective assessment of effects of treatment of cervical, fetal-membrane, and amniotic fluid infection. For example, the device 10 can determine whether “hot spots” of an infection have decreased or become less intense, indicating that a given treatment is effective. In some cases, such as with cervical or fetal membrane treatments (for ripening and/or infection) an indication of effective treatment can allow doctors or clinicians to have more confidence in letting a fetus remain in the mother for further fetal growth and development, thereby helping reduce the incidence of morbidity and mortality due to premature birth.

In addition, in some embodiments, the device 10 can be used to analyze how certain agents (drugs, chemicals, etc.) can control function of the cervix. Also, in some embodiments, the device 10 can be used to measure onset and progression of term and preterm labor. For example, the device 10 can be used for experimental procedures to assess cervical changes during pregnancy.

In one procedure, photos of the external cervix of timed-pregnant rats (e.g., 6 per group with normal delivery on day 22) were taken every other day from day 13 of pregnancy until postpartum day 5 following treatments with a control, progesterone injections (P4). P4 vaginally, 17-alpha-hydroxyprogesterone caproate (17P), or the P4 antagonist RU-486. Surface area (in square millimeters) of the cervix was estimated from photos by morphometric methods. The results of analyzing the photos showed that the surface area of the cervix in normal pregnancy continuously increased throughout gestation (almost 300% from day 13 to term reflecting ripening) and reversed postpartum. The results also showed that cervical surface area in parenterally treated P4 or 17P groups increased at a significantly lower rate than the control group. The results further showed that only for the P4-injection group had a significantly lower surface area noted on day 21 (i.e., one day before normal delivery day), that vaginal P4 did not prevent surface area increases, and that only parenteral P4 treatment blocked delivery. The results also showed that RU-486 treatment significantly increased the cervical surface area during preterm delivery. Using an optical method to assess the cervix in this procedure allowed the detection of agents that modify cervical function and helped in the determination of which agents may be more effective for treatment of preterm labor.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A cervical, fetal-membrane, and amniotic examination and assessment device for use with a computer, the device comprising:
a probe including a camera and a reference laser system,
the reference laser system including a laser located on the probe relative to the camera to illuminate a reference dot on a target area to be photographed by the camera,
the reference laser system determining a distance between the probe and a target structure within the target area;
a connector cable coupling the probe to the computer and configured to transmit images of the target area photographed by the camera and to transmit the distance determined by the reference laser system to the computer, the images including the reference dot created by the laser; and
a device program executable by the computer which analyzes the images to measure and quantify boundaries of features within the target area using the reference dot in the images and the determined distance from the reference laser system.

2. The device of claim 1 wherein the device program compares the features within the target area to other features of previously stored images accessible by the computer.

3. The device of claim 1 wherein the device program displays the images including visual boundary markings of the features on a display screen of the computer.

4. The device of claim 1 and further comprising at least one light source on the probe, the at least one light source located on the probe relative to the camera to illuminate the target area.

5. The device of claim 4 wherein the at least one light source is capable of illuminating one of visible light, infrared light, and ultraviolet light.

6. The device of claim 1 wherein the at least one light source includes a plurality of light-emitting diodes.

7. The device of claim 1 and further comprising a camera lens housing coupled to an end of the probe to seal the camera within the probe.

8. The device of claim 1 and further comprising a control panel capable of receiving user input to control at least one of the camera and the reference laser system.

9. The device of claim 1 and further including a mount coupled to the probe for one of a biopsy tool, a syringe, a scalpel, and a surgical tool.

10. A method for examining a cervix with an examination and assessment device, the method comprising:
providing the examination and assessment device with a probe including a camera and a reference laser system and coupled to a computer;
positioning a laser to illuminate a reference dot on a target area of the cervix;
calculating a first distance between the probe and the cervix using the reference laser system;
triggering an indicator light when the first distance equals a desired distance;
capturing images of the target area at the desired distance using the camera;
identifying features of the cervix by analyzing visual variations within the images; and
measuring and quantifying boundaries of the features using the desired distance and an area of the reference dot in the images.

11. The method of claim 10 and further comprising comparing the features in the images to other features of previously-stored images.

12. The method of claim 11 and further comprising classifying a condition of the cervix according to the features comparison with the previously-stored images.

13. The method of claim 12, wherein a condition of the cervix includes one of a pregnancy state, cervical ripening, an infection state, and a cervical abnormality.

14. The method of claim 10 wherein the visual variations include changes in at least one of reflection, phosphorescence, luminescence, infrared light intensities, texture, shape, size, and color.

15. The method of claim 10 and further comprising displaying the image including visual boundary markings around the features.

16. The method of claim 15 and further comprising providing an instrument for a user to manually adjust the visual boundary markings on the displayed image.

17. The method of claim 10 and further comprising illuminating the target area with light of a first frequency when capturing images of the target area at the desired distance using the camera.

18. The method of claim 10 and further comprising preparing the target area with one of an acetic acid wash, an iodine wash, a binding dye, and binding nano-particles prior to capturing images of the target area at the desired distance using the camera.

19. A method for predicting labor and delivery with an examination and assessment device inserted trans-vaginally into a cervix, the method comprising:
providing the examination and assessment device with a probe including a camera and a reference laser system and coupled to a computer;
positioning a laser to illuminate a reference dot on a target area of the cervix;
calculating a first distance between the probe and the cervix using the reference laser system;
triggering an indicator light when the first distance equals a desired distance;
capturing images of the target area at the desired distance using the camera;
identifying a boundary of the cervix by analyzing visual variations within the images; and
measuring a size of the cervix using the desired distance and an area of the reference dot in the images.

20. The method of claim 19 and further comprising capturing a sequence of images over a time period and comparing the size of the cervix across the time period to assess progression of labor.
